(19) United States
(12) Patent Application Publication
(10) Pub. No.: US 2025/0196079 A1
(43) Pub. Date: Jun. 19, 2025

(54) METHOD AND DEVICE FOR PRODUCING A LIQUID WHICH CONTAINS A HIGH CONCENTRATION OF VERY SMALL BUBBLES

(71) Applicant: OTTO-VON-GUERICKE-UNIVERSITÄT MAGDEBURG KÖRPERSCHAFT DES ÖFFENT-LICHEN RECHTS, Magdeburg (DE)

(72) Inventor: Kristin Hecht, Graben-Neudorf (DE)

(21) Appl. No.: 18/566,973

(22) PCT Filed: Jun. 3, 2022
(86) PCT No.: PCT/DE2022/000061

§ 371 Date: Jun. 26, 2024

(30) Foreign Application Priority Data
Jun. 5, 2021 (DE) 10 2021 002 892.9

(51) Int. Cl. B01F 31/65; B01F 23/232; B01F 23/2375; B01F 35/60; B01F 35/71

(52) U.S. Cl. CPC B01F 31/65; B01F 23/232; B01F 23/2375; B01F 35/602; B01F 35/7174; B01F 35/71745

(57) ABSTRACT

A method for producing a liquid containing a high concentration of tiny bubbles comprises passing liquid from a first reservoir to a second reservoir via a nanobubble generator which produces a liquid containing a high concentration of tiny bubbles.

### CROSS REFERENCE TO RELATED APPLICATION

This application claims priority from German patent application No. DE 10 2021 002 892.9, filed Jun. 5, 2021, titled METHOD AND DEVICE FOR PRODUCING A LIQUID WHICH CONTAINS A HIGH CONCENTRATION OF VERY SMALL BUBBLES, the disclosure of which is incorporated herein in its entirety by reference.

### FIELD

The claimed invention relates to a method and device for producing a liquid containing a high concentration of tiny bubbles.

### BACKGROUND

Liquids containing tiny bubbles are used in various areas, such as in medicine as ultrasound contrast agents or in the food and beverage industry, especially for cleaning.

To do this, it is necessary to generate these bubbles efficiently and in high concentrations.

### SUMMARY

The invention relates to a method for producing a liquid containing a high concentration of tiny bubbles, in which a liquid is passed from a first reservoir via a nanobubble generator into a second reservoir, and to a device for producing a liquid containing a high concentration of tiny bubbles.

### BRIEF DESCRIPTION OF THE DRAWINGS

FIG. 1: an arrangement for generating the smallest bubbles, in which a liquid flows from a first reservoir into a second reservoir; and

FIG. 2: the arrangement from FIG. 1, in which the liquid flows from the second reservoir into the first reservoir.

### DETAILED DESCRIPTION

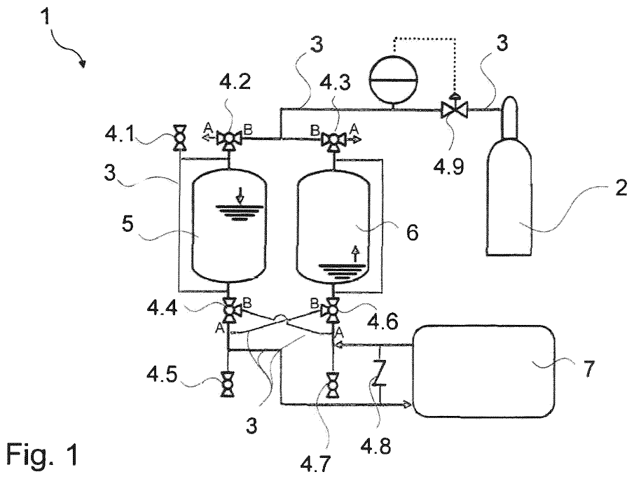

Looking to FIG. 1, an arrangement 1 for improved generation of tiny bubbles in a liquid is depicted, the system comprising a compressed gas unit 2.

The existing energy, which results from the excess pressure of the gas in the compressed gas unit 2, is used to move both the gas and the liquid through lines 3, i.e., tubular connections.

Nine valves 4.1, 4.2, 4.3, 4.4, 4.5, 4.6, 4.7, 4.8, 4.9 are arranged to control the flow of gas and liquid.

To create the smallest bubbles, liquid is first passed into a first reservoir 5.

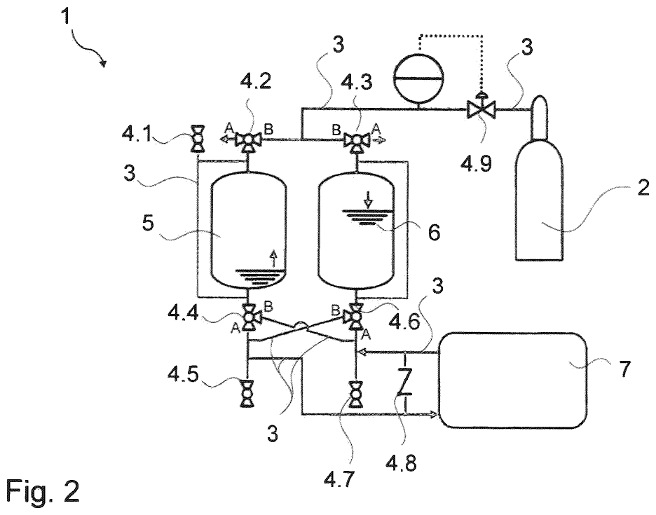

Gas from the compressed gas unit 2 is then passed into the first reservoir 5. To produce the smallest bubbles, the mixture of liquid and gas present in the first reservoir 5 is passed into the second reservoir 6, whereby it passes the nanobubble generator 7. This causes tiny bubbles to be induced in the liquid. When a sufficient amount of the mixture of liquid and gas has been introduced into the second reservoir 6, the valves 4.1, 4.2, 4.3, 4.4, 4.5, 4.6, 4.7, 4.8, 4.9 are adjusted such as shown in FIG. 2, such that the mixture of liquid and gas is fed back into the first reservoir 5, whereby the nanobubble generator 7 is also passed through the same path.

In order to be able to direct the liquid into the first reservoir 5, the valve 4.1 is opened so that the liquid can flow in via this valve 4.1.

Meanwhile, valves 4.2, 4.3 are set to position A and valves 4.5 and 4.7 are closed. Preferably, up to 5 liters or up to 20 liters of liquid are filled in via valve 4.1. Optionally, larger volumes can also be filled in an adapted arrangement. The valve 4.1 can then be closed.

In order to supply gas to the first reservoir 5, a compressed gas unit 2, such as a gas bottle, is connected to the connection arranged adjacent to valve 4.9 and a compressed gas unit valve arranged thereon, such as a gas bottle tap, is opened.

The desired pressure is set at valve 4.9, for example to 3 bar.

The liquid is passed from the first reservoir 5 via the nanobubble generator 7 into the second reservoir 6.

To do this, valve 4.2 is now set to position B and valve 4.3 to position A. Furthermore, it is relevant to also set the valves 4.4 and 4.6 to position A, shown here pointing upwards. If the compressed gas unit 2 is now opened via the compressed gas unit valve and the nanobubble generator 7 is started at the same time, the liquid is passed through the inflowing gas from the first reservoir 5 into the nanobubble generator 7, in which bubbles are indexed into the liquid. after which the liquid is guided into the second reservoir 6 by further gas flowing in. When a sufficient amount of liquid has reached the second reservoir 6, the nanobubble generator 7 can be stopped and the compressed gas unit 2 can be closed again. The amount of liquid in the second reservoir 6 can be determined using any level indicator.

To complete the process, the valve 4.2 is adjusted taking into account the pressure relief set to position A. This allows the increased gas pressure to be reduced and some of the gas to escape via valve 4.2.

To increase the bubble concentration in the liquid, the liquid can be directed from the second reservoir 6 back into the first reservoir 5, as shown in FIG. 2.

To increase efficiency, the arrangement is preferably designed in such a way that the liquid also passes through the nanobubble generator 7. To do this, the valve 4.2 is left in position A and the valve 4.3 is now set to position B so that there is a connection between the second reservoir 6 and the compressed gas unit. The valves 4.4 and 4.6 are now set to position B, shown here pointing downwards. The compressed gas unit 2 can then be opened and the nanobubble generator 7 can be started at the same time. The energy of the high-pressure gas from the compressed gas unit 2 causes the outflowing gas to flow into the second reservoir 6 and thereby direct the liquid in the direction of the valve 4.6. The liquid then flows past the valve 4.6 set to position B and through the valve 4.4 set to position B via lines 3 again into the nanobubble generator 7 and is then passed through the valve 4.6, which is set to position B.

The liquid then flows back into the first reservoir 5. If a sufficient amount of liquid has been placed in the first reservoir 5, the nanobubble generator 7 can be stopped and the compressed gas unit 2 can be closed. Here too, a level indicator can be used to determine the amount of liquid in the first reservoir 5. As such a fill level indicator, for example, the lines 3 adjacent to the respective reservoir 5, 6 or the reservoir 5, 6 itself can be formed at least in sections from a transparent material or have a viewing window, so that the fill level can be observed through this section or through the inserted viewing window.

The valve 4.3 can be set back to position A, taking into account the pressure relief, so that no further gas flows in.

It is also possible to reduce increased gas pressure via valve 4.3. For this purpose, part of the gas flows out of the second reservoir 6 via the valve 4.3. It is possible to repeat the steps described above as often as you like, i.e., the liquid, for example water, via the nanobubble generator 7 from the first reservoir 5 into the second reservoir 6 and then the liquid via the nanobubble generator 7 from the second reservoir 6 into the first reservoir 5.

In order to remove the liquid from the arrangement 1 and thus empty the arrangement 1, the valves 4.5 and 4.7 are used.

It is to be understood that while certain forms of the present invention have been illustrated and described herein, it is not to be limited to the specific forms or arrangement of parts described and shown.

1. A method for producing a liquid containing a high concentration of tiny bubbles, comprising the following steps:
a) providing a liquid in a first closed reservoir,
b) feeding the liquid under pressure from the first reservoir into a nanobubble generator and further into a second reservoir, such that smallest bubbles are generated in the liquid as it flows through the nanobubble generator,
c) passing the liquid from the second reservoir into the first reservoir, and
d) repeating steps b) and c) as often as necessary to achieve a predetermined concentration of the smallest bubbles in the liquid, wherein the force for moving the liquid is provided not being provided by a thrust force imparted by another fluid or a thrust element.

2. The method of claim 1, wherein the thrust force is provided by a gas, wherein the gas is supplied at a pressure to one of the first reservoir and the second reservoir via tubular connections, wherein a connected compressed gas unit provides gas flow into the first reservoir during step b) and provides gas flow into the second reservoir during step c) such that the thrust force for moving the liquid is provided by the gas pressure.

3. The method according to claim 1, wherein a first piston is arranged as a first thrust element within the first reservoir and a second piston is arranged as a second thrust element within the second reservoir, and wherein the first piston and the second pistons are configured such that the thrust force for moving the liquid is based on a volume reduction within the reservoirs due to a movement of the first or second piston.

4. The method according to claim 3, wherein a valve connected to the first reservoir is operated after step b) is performed to release increased gas pressure from the first reservoir.

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)
